(19) United States
(12) Patent Application Publication
(10) Pub. No.: US 2009/0293981 A1
(43) Pub. Date: Dec. 3, 2009

(54) MULTI-LAYER PIPE AND METHOD FOR ITS MANUFACTURE

(75) Inventor: Bernd Berg, Siegen (DE)

Correspondence Address: MCCORMICK, PAULDING & HUBER LLP, CITY PLACE II, 185 ASYLUM STREET, HARTFORD, CT, 06103, US

(73) Assignee: Bergrohr GmbH Siegen, Siegen (DE)

(21) Appl. No.: 12/499,437

(22) Filed: Jul. 8, 2009

Related U.S. Application Data
(62) Division of application No. 11/721,467, filed on Jul. 13, 2007.

(30) Foreign Application Priority Data
Dec. 21, 2004 (DE) 10 2004 062 697.9

(51) Int. Cl. F16L 9/18; F16L 9/14; B21C 37/14

(52) U.S. Cl. 138/148; 72/368; 138/151

(57) ABSTRACT

A method for manufacture of a multi-layer pipe (5) by means of a bending roller with individual material layers (1, 2) to be combined into the multi-layer pipe (5) being put onto each other, and the multi-layer material thus formed being shaped into a multi-layer pipe (5) by means of the bending roller, and in the final stage of pipe shaping in the bending roller and/or a subsequently used bending machine a material layer (1) acting as an internal pipe being pressed non-positively into a material layer (2) acting as an external pipe.

### CROSS REFERENCES TO RELATED APPLICATION

This application is a Divisional Application of parent application U.S. Ser. No. 11/721,467 entitled “MULTI-LAYER PIPE AND METHOD FOR ITS MANUFACTURE”, filed on Jul. 13, 2007, which in turn is a nationalization under 35 U.S.C. §371 of PCT/EP2005/013569 filed Dec. 16, 2005 claiming priority from German Application 10 2004 062697.9 filed Dec. 21, 2004. Applicant claims the benefit of the filing dates of the earlier applications under 35 U.S.C. § 120. The contents of the parent application are incorporated by reference herein.

### FIELD OF THE INVENTION

The present invention relates to a multi-layer pipe as well as a method for its manufacture. Multi-layer pipes are preferably used when high demands exist against corrosion or abrasion.

### BACKGROUND OF THE INVENTION

Corrosion-resistant pressure vessels or pressure lines can be produced in a more cost-effective way than solid versions of corresponding materials when multi-layer pipes are used. This is achieved by load distribution on a thin, corrosion-resistant internal layer (e.g. stainless and acid-resistant steel) and a high-strength and pressure-proof external layer (e.g. fine-grained structural steel). Steel consumption can be considerably decreased as a result and a large part of the remaining steel consumption can be shifted to more cost-effective materials.

In certain grades, abrasion-resistant pipelines can only be manufactured when being executed as a multi-layer pipe (for instance with mechanical bonding, see below), since materials (e.g. high-strength steels with high hardness) can be used as an internal layer which for itself cannot be processed into pipes or only under great difficulties.

Other material combinations are possible in a great diversity but basically the combination possibilities of materials are restricted in this context only by the processing methods eligible in each case.

When creating the pipe sheathing, there are two possibilities

metallurgical bonding over the entire surface (requiring cladded plates as initial semi-finished product), and

merely mechanical bonding (for instance friction bonding) between internal and external pipe—preferably internal and external plates and their welding on the plate edges

Manufacture of such multi-layer pipes is done as follows in Prior Art:

For multi-layer pipes with metallurgical bonding between the layers—for instance multi-layer pipes out of metal plates, preferably steel plates—a cladded composite plate made out of two different (steel) materials is used as an initial semi-finished product. The multi-layer pipe is then manufactured as follows:

At first die composite plate is produced by roll-bonding or explosion cladding,

then pipe forming is made in accordance with usual methods such as for example by means of a bending roller or a bending press and

subsequently welding occurs with the outer wall of the multi-layer pipe being executed in accordance with the usual pipe welding methods pursuant to the material used and inner wall welding occurring as deposition welding likewise pursuant to the material.

The disadvantage of this procedure according to Prior Art is on the one hand the high cost of the initial semi-finished product and thus also of the final product, but on the other hand also insufficient availability of the initial semi-finished product, because production capacities are very restricted for it on a world-wide basis. Thus, as far as is known to the applicant and the inventor, only a few installations exist for the production of roll-bonded multi-layer plates, for instance in Austria and in Japan, but for example, not a single one in the Federal Republic of Germany. Neither installations for explosion cladding do hardly exist as far as is known to the inventor and the applicant. For example, at Dynammit Nobel at Burbach, Federal Republic of Germany, one of a few of such plants exists. The production engineering used for it is also a great problem and therefore expensive and intricate taking into consideration in addition that it is only available for very small production lots, anyhow.

Moreover, the number of materials, which can be processed in this way, is restricted. Thus, for example, certain abrasion-resistant steels cannot be used as an internal layer, if they can hardly be welded or not welded at all due to their high carbon content.

In the case of multi-layer pipes with mechanical bonding, several—preferably two—finished pipes are used as an initial semi-finished product. The process will be explained below by way of an example with two pipes (in the event of more layers, the explanations have to be understood accordingly):

two finished pipes are manufactured in close fit and moved into each other without friction with the external pipe requiring a higher yield point than the internal pipe

by expansion (mechanically—for example, by means of an expansion die—or by fluid pressure with the pipes placed into each other being pressed into a die comprising the external pipe) the internal pipe is pressed into the external pipe by elastic expansion of the external pipe. After the expansion forces are omitted, the external pipe places itself non-positively around the internal pipe due to the higher elastic resiliency

finally the two materials are welded on their faces.

The disadvantage of this process of Prior Art is that the external pipe must have a higher yield point than the internal pipe, since otherwise the elastic resiliency of the external pipe causing the non-positive connection with the internal pipe and therefore being necessary, is missing. This is particularly disadvantageous, because high-strength materials—for instance, especially high-strength steels—as they are especially advantageous preferably for abrasion-resistant pipelines inside the pipe, have high or even very high yield points, and are therefore unsuitable for this manufacturing process.

It is therefore the object of the present invention to provide on the basis of the State of the Art a multi-layer pipe as well as a method for its manufacture, which on the one hand tries and avoids the above mentioned disadvantages and thus not requiring roll-bonded and/or explosion cladded semi-finished products but which on the other hand is neither subject to the restrictions involved in manufacture of multi-layer pipes according to the State of the Art with frictionally engaged mechanical bonding of layers among each other.

### SUMMARY OF THE INVENTION

This object is met according to the invention at first by a method for manufacture of a multi-layer pipe in which

individual material layers to be combined into a multi-layer pipe are put onto each other with a material layer, which acts as an external pipe, constituting a base plate, which has approximately alongside its two longitudinal edges or approximately parallel to it, a, preferably welded, stop edge, and the material layer above being positioned loosely between these stop edges, and

the thus constituted multi-layer material is shaped into a multi-layer pipe by means of the bending roller with the material layer, which acts as an internal pipe, being clamped between the stop edges and the material layer, which acts as an internal pipe, in the final stage of the pipe shaping in the bending roller and/or bending machine subsequently used being pressed as a result nonpositively into the material layer acting as an external pipe.

but also

by a multi-layer pipe according to the invention characterised in that the material layer positioned inside has a higher yield point or proof stress compared with the outer material layer, where no metallurgical connection of adjacent layers over the entire surface exists and where these pipes can be manufactured by the method solving the above mentioned problem according to the invention, and

by a double-layer pipe as a multi-layer pipe with an external pipe and an internal pipe characterised according to the invention in that the material layer acting as an internal pipe is pressed into the material layer acting as an external pipe in such a way that the force of pressure of the internal pipe against the external pipe is at least as high as the pressure force appearing from the degree of upsetting of the internal pipe in order to reach the upsetting limit of the internal pipe.

Preferred embodiments could be found in the dependent claims.

Here, application of roll-bonded and/or explosion cladded semi-finished products can be avoided by pressing the respective material layer acting as an internal pipe already during pipe forming in the bending roller and/or the bending machine, usually necessary for final shaping, non-positively into the material layer acting as an external pipe so that it is frictionally maintained in the respective external pipe without the necessity to expand the multi-layer pipe and thus running into the disadvantages already mentioned. It is pointed out that in some cases, however, final forming or shaping is already possible in the bending roller alone, for example, in the event of shorter bending rollers which can include the function of end forming of the pipe. In that cases a bending machine is not included in the method according to the invention.

If in this text a connection alongside an edge or alongside a (preferably only imaginary) line is mentioned, any type of connection alongside the edge or line is meant, whether this connection exists alongside the entire edge or line or only in sections alongside the edge or line or only in individual spots (such as for example spot welding), for example in two spots—preferably at the end spots of the edge or line—or even only in an individual spot on the edge or on the line.

The manufacture of multi-layer pipes according to the invention can be done apart from the inventive method also by the patented method according to EP 1 827 727 B9 by means of a bending roller such that

individual material layers to be combined into the multi-layer pipe are put onto each other,

subsequently a first connection between the material layers is created,

the thus formed multi-layer material is shaped into a pipe by means of the bending roller with a constant friction-tight connection being created between the material layers as a result of the pressure of the rollers from the top and from the bottom, and during shaping, the portions of the material layers, which can still shift freely against other, shifting freely to each other in accordance with the shaping progress due to the different bend radii of internal pipe and external pipe,

after a definite shaping progress at least one other connection is created between the material layers by connecting them to each other in at least one other position, and

the multi-layer pipe is then finish-shaped by means of the bending roller and/or bending machine, with the material layers shifting no more against each other now during this finish-shaping, so that as a result, the material layer acting as an internal pipe is pressed non-positively into the material layer acting as an external pipe.

Thereby a first connection between the material layers can be created by connecting them to each other approximately alongside a longitudinal edge or transverse edge of the material layer positioned above, or approximately alongside a line parallel to it. The at least one other connection between the material layers after a definite shaping progress can occur approximately alongside a second longitudinal edge or transverse edge of the material layer, or approximately alongside a line parallel to it.

In another preferred embodiment of the method for manufacture of a multi-layer pipe by means of a bending roller according to the present invention,

the first connection between the material layers is created by connecting them alongside one of the longitudinal or transverse edges of the material layer resting on the other material layer, and

at least one other connection occurs between the material layers after a definite shaping progress alongside the second longitudinal or transverse edge of the material layer resting on the other material layer.

The at least one other connection between the material layers can, for example, be created after a shaping progress between 50% and less than 100%.

The multi-layer pipes according to the invention, especially also the double-layer pipe as a multi-layer pipe with an external pipe and an internal pipe according to the invention can be manufactured by a method for manufacture of a double-layer pipe as a multi-layer pipe with an external pipe and an internal pipe by means of a bending roller according to the present invention, where the shaping progress occurs after the at least one other connection between the material layers is made—called F_{for}, here and indicated in parts percent—preferably approximately as follows:

$${F}_{for} = ( 1 - \frac{\frac{{σ}_{I}}{E} \cdot ( DA - 2 \cdot SA - SI ) \cdot π \cdot ( {Z}_{s} + 1 )}{( DA - SA ) \cdot π - ( DA - 2 \cdot SA - SI ) \cdot π} ) \cdot 100$$

with DA being the external diameter of the external pipe in mm,
SA being the wall thickness of the external pipe in mm,
SI being the wall thickness of the internal pipe in mm,
σ_{I} being the yield point of the internal pipe in N/mm²
Zₛ being the upsetting allowance indicated in parts percent and
E being the Young's modulus in N/mm².

The above mentioned expression results from the following relations:

The length of the neutral fibre of the external pipe—here called L_{nfa}—is:

L_{nfa}=(DA−SA)·π

The length of the neutral fibre of the internal pipe—here called L_{nft}—is:

L_{nfi}=(DA−2·SA−SI)·π

Shifting of the free plate edge at 100% degree of shaping of the pipe—here called L_{fv}—is then:

L_{fv}=L_{nfa}−L_{nfi}

The degree of upsetting of the internal pipe in order to reach the upsetting limit—here called ε_{St}

—results as follows:

$${ɛ}_{St} = \frac{{σ}_{I}}{E}$$

and the length of upsetting in order to reach the upsetting limit results as

L_{St}=ε_{St}·L_{nfi}·(Zₛ+1)

The shaping progress during which further connection between the material layers takes place—here called F_{for}—is then (indicated as a value between 0 and 1) approximately:

$${F}_{for} = 1 - \frac{{L}_{st}}{{L}_{fv}}$$

and indicated in parts percent:

$${F}_{for} = ( 1 - \frac{{L}_{st}}{{L}_{fv}} ) \cdot 100$$

If this expression is resolved with:

DA being the external diameter of the external pipe in mm,
SA being the wall thickness of the external pipe in mm,
SI being the wall thickness of the internal pipe in mm,
σ_{I} being the yield point of the internal pipe in N/mm²
Zs being the upsetting allowance indicated in parts percent and
E being the Young's modulus in N/mm²
one gets the expression for the shaping progress already specified at the beginning where the further connection takes place between the materials—here called F_{for}—and indicated in parts percent. The upsetting allowance takes into account production inaccuracy in locating the at least one other material layer connection and compensates it in such a way that the intended force of pressure of the internal pipe against the external pipe is at least achieved.

Some examples are intended to illustrate this with the minimum and maximum as well as the typical example referring to the percentage degree of shaping at which the at least one other connection between the material layers occurs:

TABLE 1
Examples for Determination of the Shaping Progress
for one other Connection of the Material Layers

| | | eventual | typical | eventual |
|---|---|---|---|---|
| | | minimum | example | maximum |
| Given are: | unit | ex. 1 | ex. 2 | ex. 3 |
| DA (external diameter of external pipe) | mm | 406 | 762 | 2500 |
| SA (wall thickness of the external pipe) | mm | 25 | 20 | 12 |
| SI (wall thickness of the internal pipe) | mm | 10 | 3 | 1 |
| σ_{I} (yield point of internal pipe) | N/mm² | 100 | 350 | 480 |
| Zs(upsetting allowance) | (%) | 0% | 50% | 15% |
| E (Young's modulus) | N/mm² | 210,000 | 210,000 | 210,000 |

The searched quantities are then as follows:

TABLE 2
Searched Quantities for the Examples for Determination of the Shaping
Progress for another Connection of the Material Layers from Table 1

| For the examples given in table | | | eventual | typical | eventual |
|---|---|---|---|---|---|
| 1, the following results for the | | | minimum | example | maximum |
| searched quantities: | | unit | ex. 1 | ex. 2 | ex. 3 |
| length of the neutral | L_{nfa} = (DA − SA)*π | mm | 1,196.9 | 2,331.1 | 7,816.3 |
| fibre of the external pipe: | | | | | |
| length of the neutral | L_{nfi} = (DA − 2*SA − SI)* π | mm | 1,087.0 | 2,258.8 | 7,775.4 |
| fibre of the internal pipe: | | | | | |
| shifting of the free plate | L_{fv} = L_{nfa} − L_{nfi} | mm | 110.0 | 72.3 | 40.8 |
| edge at 100% shaping: | | | | | |
| degree of upsetting of the | ε_{St} = σ_{I}/(E | (%) | 0.05% | 0.17% | 0.23% |
| internal pipe in order to | | | | | |
| achieve the upsetting limit: | | | | | |
| length of upsetting in order | Lₛₜ = ε_{St} · L_{nfi} · Zₛ | mm | 0.52 | 5.65 | 20.44 |
| to achieve the upsetting limit: | | | | | |
| required degree of shaping for the | F_{for} = 1 − Lₛₜ/L_{fv} | (%) | 99.5% | 92.2% | 50.0% |
| at least one other connection, for | | | | | |
| example for locating the second | | | | | |
| plate edge: | | | | | |

Another method for manufacture of a multi-layer pipe according to the invention is characterised in that at least one of the material layers comprises more than one element positioned above, preferably more than one plate. The elements positioned above can be positioned with their longitudinal edge in parallel to the material layer below but this must not be the case. Thus it is also possible that they are positioned transversely to it with their longitudinal edge.

If the elements are with their longitudinal edge in parallel—preferably approximately parallel—to the longitudinal edge of the material layer below, the first connection between the material layers is preferably created by the elements, preferably plates, after their positioning on top along-side their joining location, which at the same time constitutes each a longitudinal edge of the elements, preferably plates, of the material layer on top, being connected with the material layers below, preferably the plate below.

This method is particularly suitable for the manufacture of multi-layer pipes according to the present invention having large diameters, preferably greater than 610 mm (24″), where often the width of available internal layer material strips, preferably steel strips (steel plates), is not sufficient, in order to produce an entire internal layer for such large pipes. If even two strips are not sufficient, the procedure can be continued at will: in that case three or even more elements, preferably plates, are positioned.

In the method for manufacture of a multi-layer pipe by means of a bending roller according to the present invention, the multi-layer pipe is preferably closed by welding of the external pipe alongside the pipe seam and a deposition welding of the internal pipe in order to produce the multi-layer pipe body.

Also, the material layers can be connected on the pipe faces, for example to prevent that humidity penetrates between the material layers which are metallurgical not connected over the entice surface.

A preferred application of the methods for manufacture of pipes according to the invention, especially the method of the present invention itself, is the manufacture of inventive double-layer pipes, although the invention is not restricted to it. Also three-, four-layer pipes and pipes with even more layers can generally be produced according to the present invention which is far more difficult in Prior Art or even not possible at all.

In another especially preferred embodiment of the present invention, plates, preferably metal plates, and more preferably, steel plates, are used as material layers or elements of the material layer.

Also, in the above mentioned method for manufacture of pipes according to the invention, preferably at least one of the connections of the material layers is made as a welding, which is particularly suitable for the metal plates, preferably steel plates, mentioned above.

According to the method of the present invention also such materials—as for example very high-strength steels—can be used as a respective internal layer which cannot be welded or can be welded only under great difficulties. The principle of the invention remains: The material layer acting as an internal pipe already during pipe shaping in the bending roller is non-positively pressed into the material layer acting as an external pipe and thus frictionally maintained in the respective external pipe.

A gap is preferably left between the edges of the material layer positioned on top and the stop edges which will close only during the pipe shaping process.

After forming of the pipe body, the material layer acting as an internal pipe due to the impact of force can be shifted within the material layer acting as an external pipe so that a plug-in sleeve is formed permitting pipes to be plugged into each other so that pipe assembly on site is extremely simplified.

For completion of the pipe body also in this embodiment of the procedure according to the present invention welding of the external pipe is preferably done alongside the pipe seam.

The inventive multi-layer pipe, in particular the multi-layer pipe obtained according to the inventive method, is formed in particular such that a material layer positioned inside has a higher yield point or proof stress (see below) compared with the outer material layer with at least one material layer comprising preferably a metal plate, and more preferably, a steel plate.

An especially preferred embodiment of a multi-layer pipe according to the present invention is characterised in that the multi-layer pipe is formed as a double-layer pipe exhibiting two steel plate material layers with. the steel plate, which acts as an internal pipe, having a high up to a very high carbon content and thus is at least not necessarily weldable any more.

The multi-layer pipes obtained in such a way according to the present invention are different from those of Prior Art in a variety of ways but without these differences having to become evident all at the same dine in one multi-layer pipe according to the present invention which could be identified accordingly. Rather these difference can also occur in different combinations among each other but need not do so necessarily.

Thus according to the present invention it is on the one hand not necessary to use cladded plates (with the disadvantages, already discussed at the beginning, of long delivery times and limited availability as well as high prices), on the other hand nevertheless multi-layer pipes—especially double-layer pipes out of steel plate material layers—with a high yield point of the material of the respective internal pipe and simultaneous low yield point of the material of the respective external pipe can be manufactured, which is necessary, for example, for such applications of multi-layer pipes requiring a possibly high abrasion resistance of the internal pipe, since high abrasion resistance normally coincides also with a high hardness which in turn coincides with a high yield point. Such multi-layer pipes having an internal pipe made out of a material with a higher or the same yield point than the respective external pipe but which have nevertheless no metallurgical connection of adjacent layers over the entire surface, cannot be manufactured according to Prior Art. They do not exist until now. But they become possible due to the present invention. It must be pointed out that in the event of a not very distinct yield point—for example, in cases of only increased plastic deformation—the proof stress will be substituted for the yield point as the amount of stress of a plastic permanent expansion under a certain impact of force.

Independent of what has been said above, the method according to the present invention permits in addition a far greater plurality of material combinations for the inventive multi-layer pipes. For example, in Prior Art certain abrasion-resistant steels cannot be used as an internal layer, since these not only due to the high yield point usually coinciding with their high abrasion resistance are not suitable to be used alone (e.g. as a single layer pipe) for the pipe shaping process, and also would have to be welded for internal pipe formation, but are hardly or not at all suitable for it due to their high carbon content, i.e. cannot necessarily be welded (see above). Therefore, corresponding pipes do likewise not exist until today. But the method according to the present invention, which in a preferred embodiment takes advantage of the non-positive pressing of the respective internal pipe into the respective external pipe during the manufacturing process, permits manufacture also of such multi-layer pipes, which use as an internal layer a non-weldable or not necessarily weldable material—for example a steel with a high, and preferably very high carbon content—. Thus also the use of materials not weldable at all such as for example modern plastics having the desired properties of an internal pipe layer, becomes possible at all. Pipes with such internal layers do likewise not exist until today.

Again independent of it, also multi-layer pipes can be manufactured by means of the method according to the present invention, without using expensive and hardly available, cladded plates (mechanically connected over the entire surface), in almost any large diameters, which is not possible according to Prior Art, since here the necessary expansion is limited by the dimensions of the expansion die used, or by a die necessary for uniform shaping in the case of a hydraulic expansion force impact which encloses the multi-layer pipe to be manufactured. Compared with this the inventive roll bending process permits multi-layer pipes, which are not subject to such predetermined limitations, since the bending roller, which intervenes for shaping purposes always only in one location of the pipe radius of curvature, does not limit the diameter of the inventive multi-layer pipe. Thus in particular also multi-layer pipes without cladded plates can be manufactured which exceed—and preferably exceed by far—the limit of the present State of the Art of a diameter of approx. 610 mm (24″).

The present invention permits manufacture of multi-layer pipes with partial internal layer at all, i.e. an internal pipe forming a graduated circle in cross-section, for example in the form of a channel insert at the pipe base which is likewise not possible in Prior Art until now.

In this connection it should be mentioned that according to the method of the present invention of course also pipes in only very small quantities, especially also individual pipes, can be economically manufactured, which in Prior Art on the one hand is impeded by the intricate cladding and the minimum production lots necessary for it, and on the other hand by the especially set up tools and appliances required for expansion.

### BRIEF DESCRIPTION OF THE DRAWINGS

Below, non-limitative embodiments will be discussed by means of the drawings, in which

FIG. 1 is a perspective plan view of two material layers, to be combined into a multi-layer pipe, put onto each other,

FIG. 2 is a perspective plan view of two material layers, to be combined into a multi-layer pipe, put onto each other, with a first connection, preferably welding, between the material layers, approximately alongside an (imaginary) line parallel to one longitudinal edge of the material layer positioned above.

FIG. 3 is a perspective plan view of two material layers, to be combined into a multi-layer pipe, put onto each other, with one of the material layers comprising two elements—preferably plates—placed in longitudinal pipe direction,

FIG. 3a is another perspective plan view of two material layers, to be combined into a multi-layer pipe, put onto each other, with one of the material layers, namely the material layer placed above, constituting a plurality of elements—preferably plates—placed in circumferential pipe direction,

FIG. 4 is a perspective plan view of two material layers, to be combined into a multi-layer pipe, put onto each other, with one of the material layers comprising more than one, namely two elements here—preferably plates—placed above, and a first connection was created here between the material layers by connecting—preferably welding—the elements with the material layer below, after their positioning alongside their joining location, which at the same time constitutes each a longitudinal edge of the elements of the material layer placed above,

FIG. 5 a perspective view from a front into a multi-layer pipe according to the present invention during the manufacturing process, namely in the process step where the thus formed multi-layer material is shaped into a pipe by means of the bending roller (not shown here) with a constant friction-tight connection being created between the material layers as a result of the pressure of the rollers from the top and from the bottom, and during shaping, the portions of the material layers, which can still shift freely against each other, shifting freely to each other in accordance with the shaping progress due to the different bend radii, of internal pipe and external pipe,

FIG. 6 a perspective view from a front into a multi-layer pipe according to the present invention during the manufacturing process, namely in the process step where after a definite shaping progress at least one other connection between the material layers is created by connecting the material layer positioned on top in at least one other position to each other,

FIG. 7 a perspective cross-section of a finished multi-layer pipe according to the present invention with internal and external layer,

FIG. 8 a perspective cross-section of a multi-layer pipe with internal and external layer with detailed view in the area of the weld seam,

FIG. 9 a perspective view of the base plate subsequently constituting the external pipe, with stop edges, and the internal plate subsequently constituting the internal pipe, in the still flat, unworked condition, and

FIG. 10 a perspective cross-section of a multi-layer pipe according to the present invention with the base plate of the external plate exhibiting stop edges and the internal plate constituting the internal pipe being clamped in-between these stop edges after the corresponding shaping progress.

### DESCRIPTION OF THE PREFERRED EMBODIMENTS

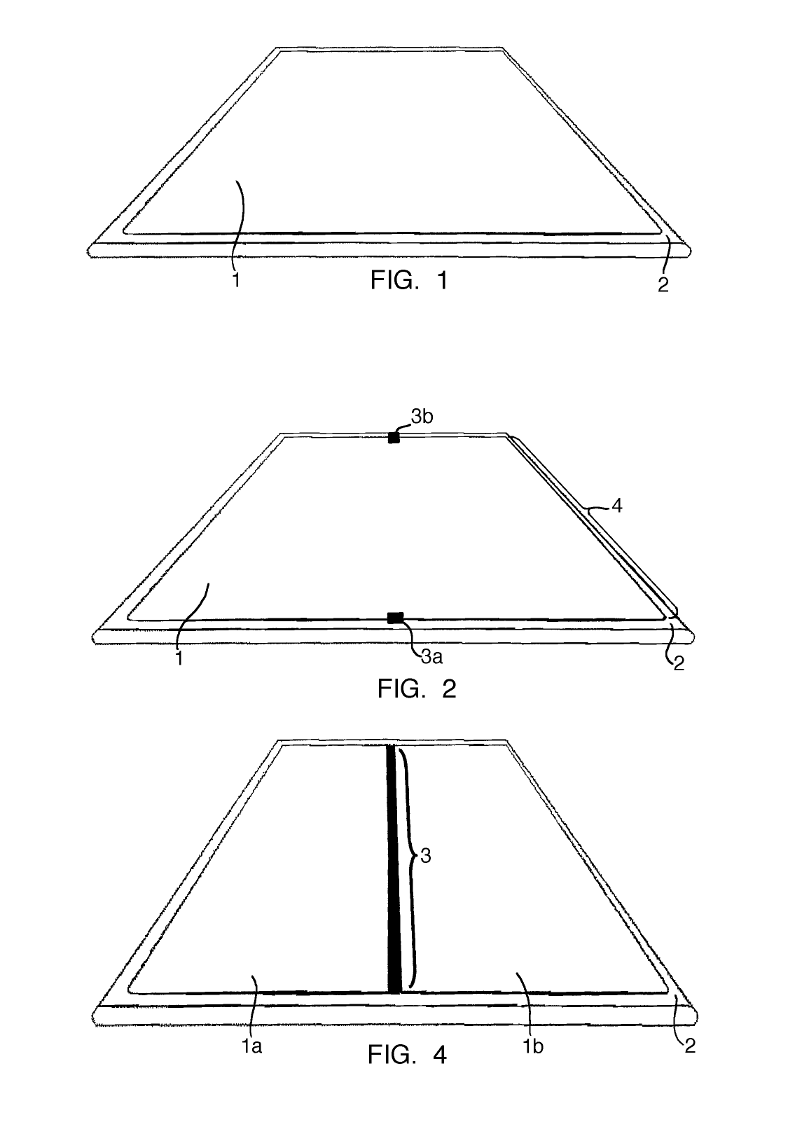

FIG. 1 shows a perspective plan view of two material layers 1, 2, to be combined into a multi-layer pipe, put onto each other.

FIG. 2 shows a perspective plan view of two material layers, to be combined into a multi-layer pipe, put onto each other, with a first connection 3a and 3b—preferably welding (namely in the points 3a and 3b)—between the material layers 1,2, approximately alongside an (imaginary) line parallel to a longitudinal edge 4 of the material layer positioned above 1.

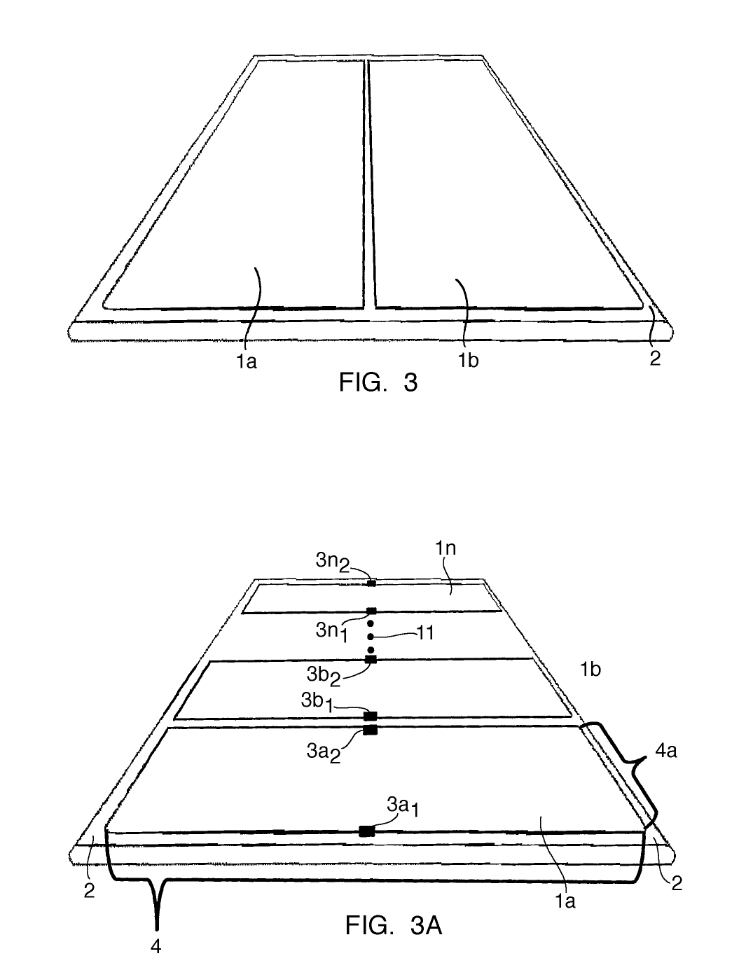

FIG. 3 is a perspective plan view of two material layers 1a, 1b, 2, to be combined into a multi-layer pipe, put onto each other, with one of the material layers here, namely the material layer placed above, comprising two elements 1a, 1b—preferably plates—placed in longitudinal pipe direction.

FIG. 3a is another perspective plan view of two material layers 1a, 1b, . . . , 1n, 2, to be combined into a multi-layer pipe, put onto each other, with one of the material layers here, namely the material layer placed above, constituting a plurality, namely a finite number—here called n—of elements 1a, 1b . . . 1n—preferably plates—placed in circumferential pipe direction. The fact that it may be any number of n elements 1a, 1b, . . . , 1n placed above, is specified in the drawing by a dotted line 11.

The elements placed above 1a, 1b . . . 1n are here placed with their longitudinal edge 4 transversely to the longitudinal edge of the material layer 2 placed below, whereas with their respective transverse edge 4a they are here placed parallel to the longitudinal edge of the material layer 2 placed below. Also, the respective first connections 3a₁, 3a₂, 3b₁, 3b₂, 3n₁, 3n₂ provided in this arrangement of the elements 1a, 1b . . . 1n placed onto material layer 2 can be seen here.

FIG. 4 shows a perspective plan view of two material layers 1a, 1b, 2, to be combined into a multi-layer pipe, put onto each other, with one of the material layers comprising more than one, namely two elements 1a, 1b here—preferably plates—placed above, and a first connection 3 was created here between the material layers by connecting, preferably welding, the elements 1a, 1b with the material layer 2 below, after their positioning alongside their joining location, which at the same time constitutes each a longitudinal edge of the elements 1a, 1b of the material layer placed above. Here, this connection 3 was made alongside the joining location and at the same time longitudinal edge by a closed connection 3, preferably welding, extending over the entire length of the joining location and at the same time longitudinal edge. In particular a connection in sections, preferably, welding, is possible.

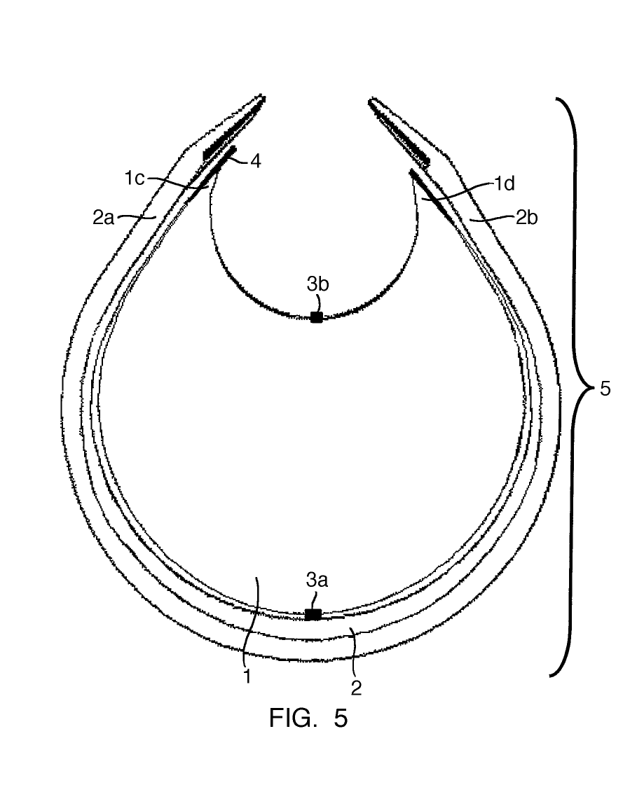

FIG. 5 shows a perspective view from a front into a multi-layer pipe 5 according to the present invention during the manufacturing process, namely in the process step where the thus formed multi-layer material is shaped into pipe 5 by means of the bending roller (not shown here) with a constant friction-tight connection being created between the material layers 1, 2 as a result of the pressure of the rollers from the top and from the bottom, and during shaping, the portions 1c against 2a, as well as 1d against 2b of the material layers, which can still shift freely against each other, shifting freely to each other in accordance with the shaping progress due to the different bend radii of internal pipe 1 and external pipe 2. The first connection 3a, 3b between the two material layers 1, 2 was made here already in two points 3a, 3b which are located alongside an (imaginary) line parallel to a longitudinal edge of the internal pipe 2, which is forming—namely at the end points there. But in the area of this first connection 3a and 3b of the material layers 1, 2, these, due to their connection 3a and 3b with each other, can now no longer shift against each other but remain immobilised or held in position against each other here.

FIG. 6 shows a perspective view from a front into a multi-layer pipe 5 according to the present invention during the manufacturing process, namely in the process step where after a definite shaping progress at least one other connection—two other connections here —6a and 6b, here formed as a continuous or partial weld seam, between the material layers 1, 2 was created by connecting the material layer 1 positioned on top in at least one other position—in two other positions here—to each other. Subsequently the multi-layer pipe 5 can then be finish-shaped (not shown) by means of the bending roller and/or bending machine, with the material layers shifting no more against each other now during this finish-shaping due to the other connections 6a and 6b, so that as a result, the material layer 1, 1c, 1d acting as an internal pipe is pressed non-positively into the material layer 2,2a, 2b acting as an external pipe.

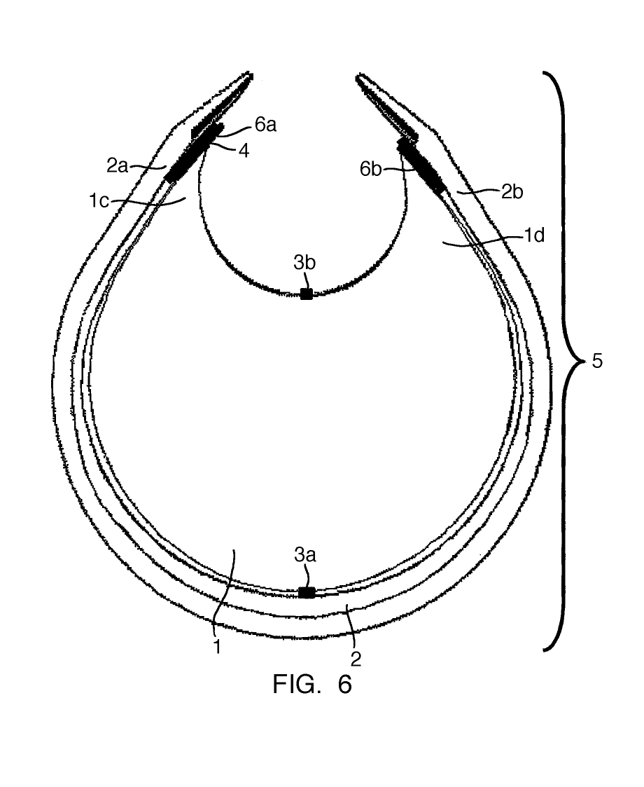

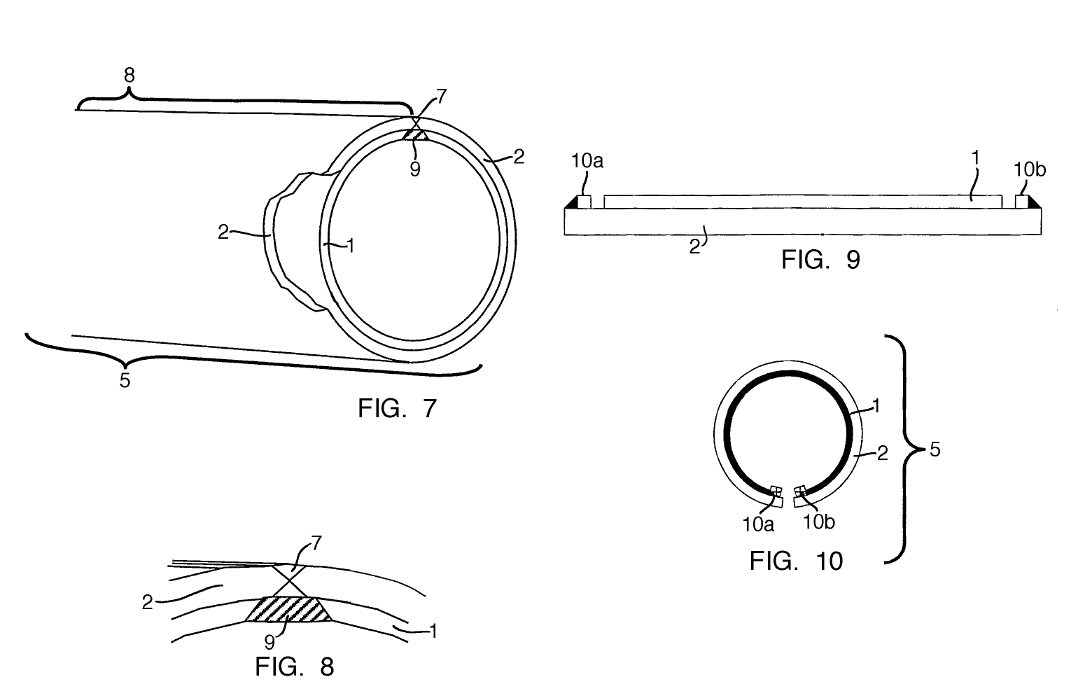

FIG. 7 shows a perspective cross-section of a finished multi-layer pipe 5 according to the present invention with internal layer (also called internal pipe, internal pipeline, internal plate etc.) 1 and external layer (also called external pipe, external pipeline, base plate etc.) 2 with the multi-layer pipe 5 having been closed by means of welding 7 of the external pipe 2 alongside a pipe seam 8 and deposition welding 9 of the internal pipe 1.

FIG. 8 shows a perspective cross-section of a multi-layer pipe according to FIG. 7 with internal layer 1 and external layer 2 in detailed view in the area of the two weld seams 7,9.

FIG. 9 shows a perspective view of the base plate 2 subsequently constituting the external pipe, with stop edges 10a, 10b, and the internal plate 1 subsequently constituting the internal pipe, in the still flat, unworked condition. The multi-layer material thus formed is shaped into a multi-layer pipe according to the present invention by means of a bending roller with the material layer 1 acting as an internal pipe being clamped between the stop edges 10a, 10b and thus being pressed non-positively into the material layer 2 acting as an external pipe. One can also see here that between the edges of the material layer above and the stop edges 10a, 10b, a gap is left which closes only during the pipe shaping process.

FIG. 10 shows a cross-section of a multi-layer pipe 5 according to the present invention with the base plate of the external plate 2 exhibiting stop edges 10a, 10b and the internal plate 1 constituting the internal pipe being clamped in-between these stop edges 10a, 10b after corresponding shaping progress and thus being pressed non-positively into the external pipe 1 as a result of the bending process. The gap between the edges of the material layer above and the stop edges 10a, 10b has already closed before.

1. A method for manufacture of a multi-layer pipe by means of a bending roller, characterised in that
individual material layers to be combined into a multi-layer pipe are put onto each other with a material layer acting as an external pipe constituting a base plate having approximately alongside its two longitudinal edges or approximately parallel to it a, preferably welded, stop edge, and the material layer above being positioned loosely between these stop edges, and
the thus constituted multi-layer material is shaped into a multi-layer pipe by means of the bending roller with the material layer acting as an internal pipe being clamped between the stop edges and the material layer acting as an internal pipe in the final stage of the pipe shaping in the bending roller and/or bending machine subsequently used being pressed as a result non-positively into the material layer acting as an external pipe.

2. A method for manufacture of a multi-layer pipe by means of a bending roller according to claim 1, characterised in that the material layer acting as an internal pipe in the finished multi-layer pipe constitutes a graduated circle in cross-section and thus preferably forms a channel at the base of the multi-layer pipe.

3. A method for manufacture of a multi-layer pipe by means of a bending roller according to claim 1, characterised in that individual material layers to be combined into the multi-layer pipe, are put onto each other, with a gap being kept between the edges of the material layer above and the stop edges which closes only during the pipe shaping process.

4. A method for manufacture of a multi-layer pipe by means of a bending roller according to claim 1 characterised in that
after forming of the pipe body, the material layer acting as an internal pipe due to the impact of force can be shifted within the material layer acting as an external pipe so that a plug-in sleeve is formed permitting pipes to be plugged into each other.

5. A method for manufacture of a multi-layer pipe by means of a bending roller according to claim 1 characterised in that the multi-layer pipe is closed by means of welding of the external pipe alongside the pipe seam.

6. Multi-layer pipe, characterised in that the material layer positioned inside has a higher yield point or proof stress compared with the outer material layer, where no metallurgical connection of adjacent layers over the entire surface exists.

7. Multi-layer pipe according to claim 6, characterised in that at least one material layer comprises a metal plate.

8. Multi-layer pipe according to claim 7, characterised in that at least one material layer comprises a steel plate.

9. Multi-layer pipe according to claim 8, characterised in that the multi-layer pipe is formed as a double-layer pipe exhibiting two steel plate material layers with the steel plate layer, which acts as an internal pipe, having a high up to a very high carbon content and thus is not necessarily weldable any more.

10. Double-layer pipe as a multi-layer pipe with an external pipe and an internal pipe, characterised in that the material layer acting as an internal pipe is pressed into the material layer acting as an external pipe in such a way that the force of pressure of the internal pipe against the external pipe is at least as high as the pressure force appearing from the degree of upsetting of the internal pipe that is necessary to reach the upsetting limit of the internal pipe.
